(19) United States
(12) Patent Application Publication
(10) Pub. No.: US 2015/0049466 A1
(43) Pub. Date: Feb. 19, 2015

(54) Tru-Traffic

(71) Applicant: Renald Surpris, Lilburn, GA (US)

(72) Inventor: Renald Surpris, Lilburn, GA (US)

(21) Appl. No.: 14/459,314

(22) Filed: Aug. 14, 2014

Related U.S. Application Data
(60) Provisional application No. 61/865,799, filed on Aug. 14, 2013.

(51) Int. Cl. F21V 33/00; A41D 13/01

(52) U.S. Cl. CPC F21V 33/0064; A41D 13/01; F21W 2111/10
USPC 362/108

(57) ABSTRACT

A visibility increasing harness assembly includes a belt configured for extending around a person's torso. A strap has a first end and a second end. The first and second ends are each attached to the belt. The strap is extendable over a person's shoulders. The strap has an outer surface. A plurality of light emitters is positioned on the outer surface. The strap includes a first portion including the first end, a second portion including a second portion including the second end, and a middle portion positioned between the first and second portions. The middle portion has an aperture therein dividing the middle portion into a pair of sections. The aperture receives the person's head.

### BACKGROUND OF THE DISCLOSURE

### Field of the Disclosure

The disclosure relates to wearable visibility increasing devices and more particularly pertains to a new wearable visibility increasing device for increasing the visibility of the person wearing the device.

### SUMMARY OF THE DISCLOSURE

An embodiment of the disclosure meets the needs presented above by generally comprising a belt configured for extending around a person's torso. A strap has a first end and a second end. The first and second ends are each attached to the belt. The strap is configured to be extended over a person's shoulders. The strap has an outer surface. A plurality of light emitters is positioned on the outer surface. The strap includes a first portion including the first end, a second portion including a second portion including the second end, and a middle portion positioned between the first and second portions. The middle portion has an aperture therein dividing the middle portion into a pair of sections. The aperture is configured to receive the person's head.
There has thus been outlined, rather broadly, the more important features of the disclosure in order that the detailed description thereof that follows may be better understood, and in order that the present contribution to the art may be better appreciated.
There are additional features of the disclosure that will be described hereinafter and which will form the subject matter of the claims appended hereto.
The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a visibility increasing harness assembly according to an embodiment of the disclosure.

FIG. 2 is a side view of an embodiment of the disclosure.

FIG. 3 is a rear view of an embodiment of the disclosure.

FIG. 4 is a schematic view of an embodiment of the disclosure.

FIG. 5 is a bottom view of an embodiment of the disclosure.

FIG. 6 is a WAND view of an embodiment of the disclosure.

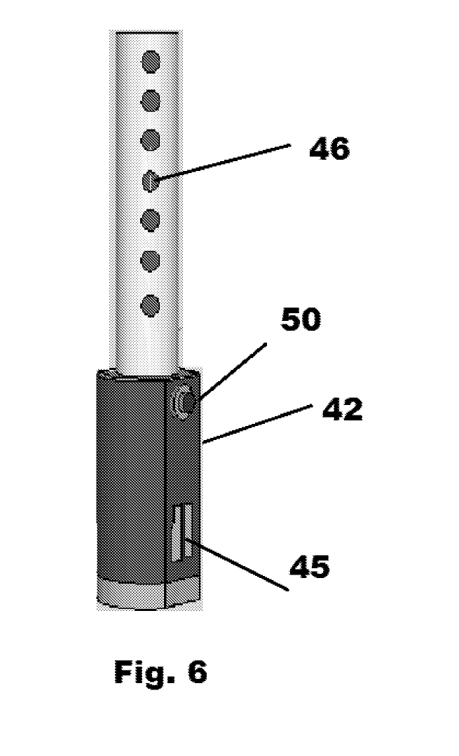

### DESCRIPTION OF THE PREFERRED EMBODIMENT

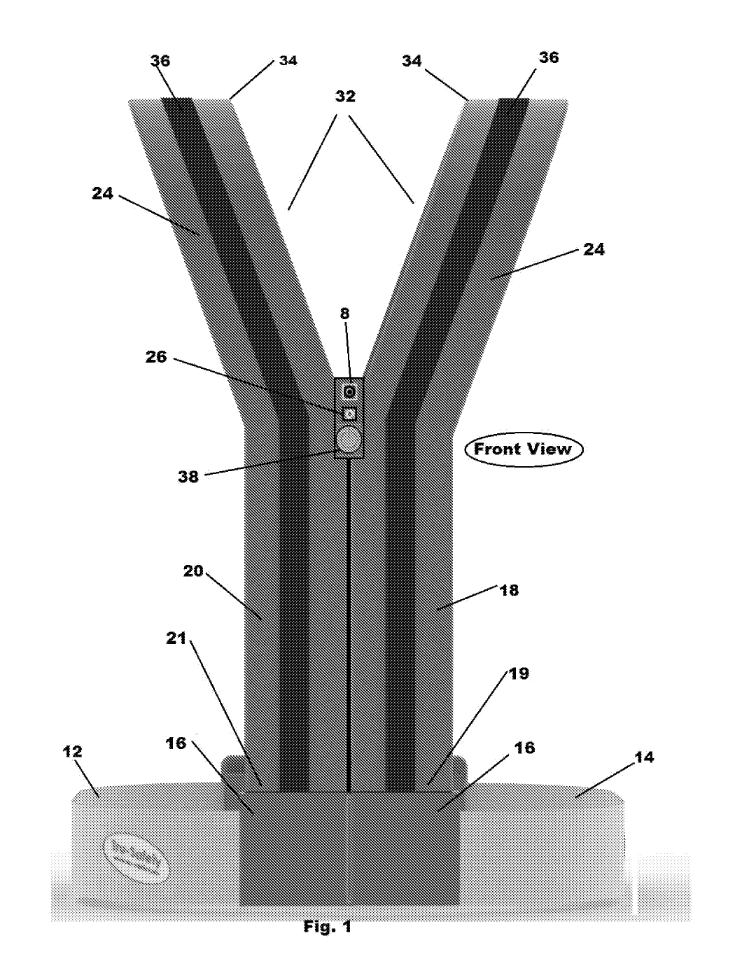

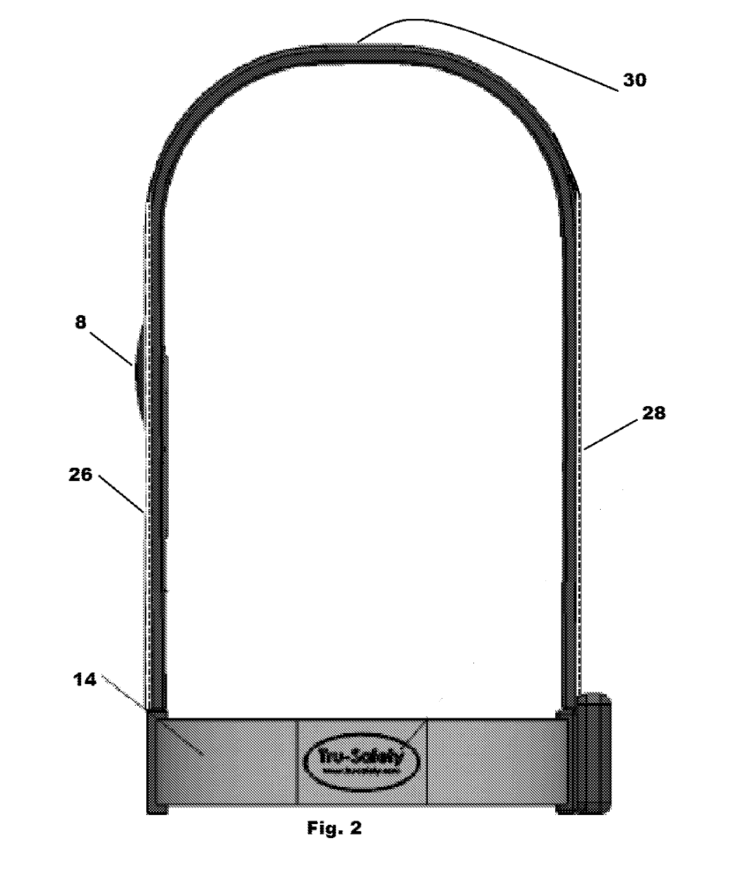

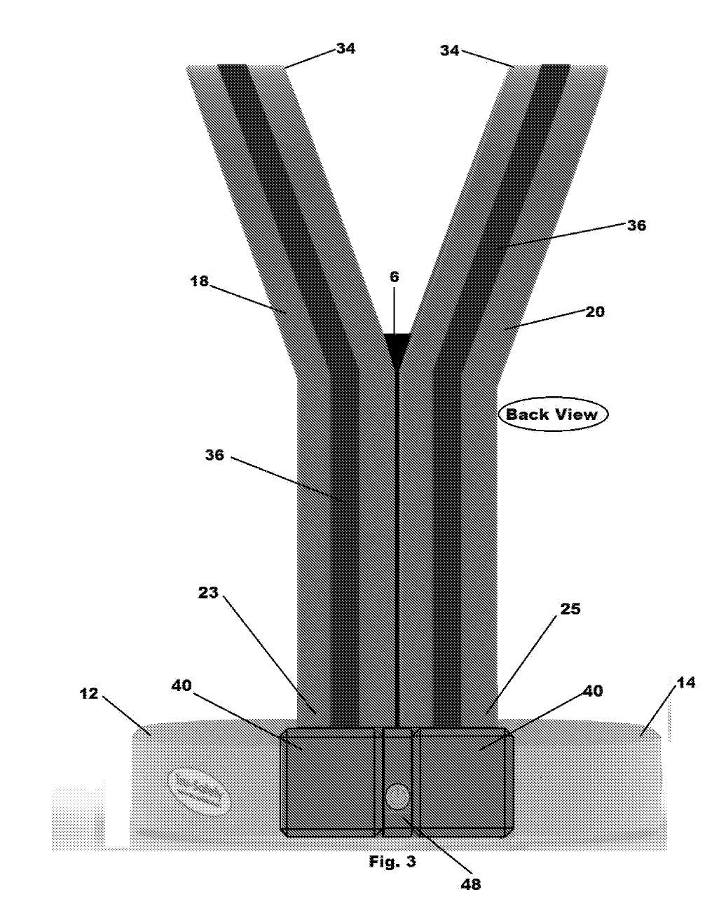

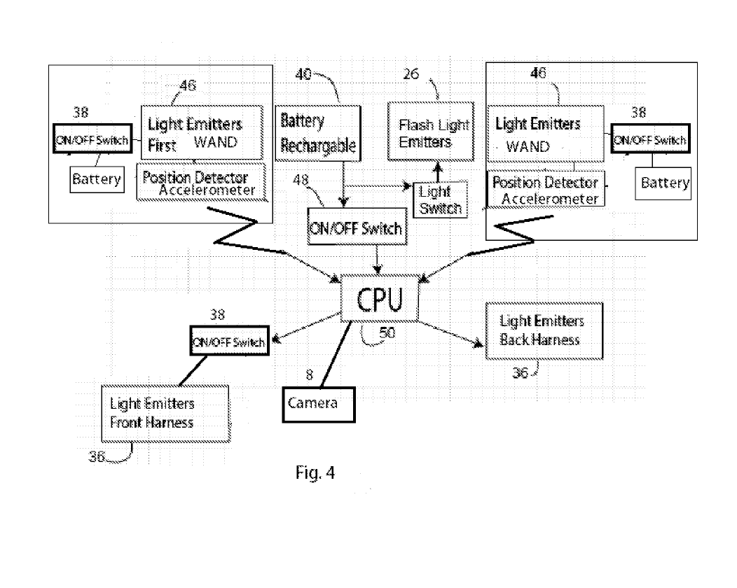

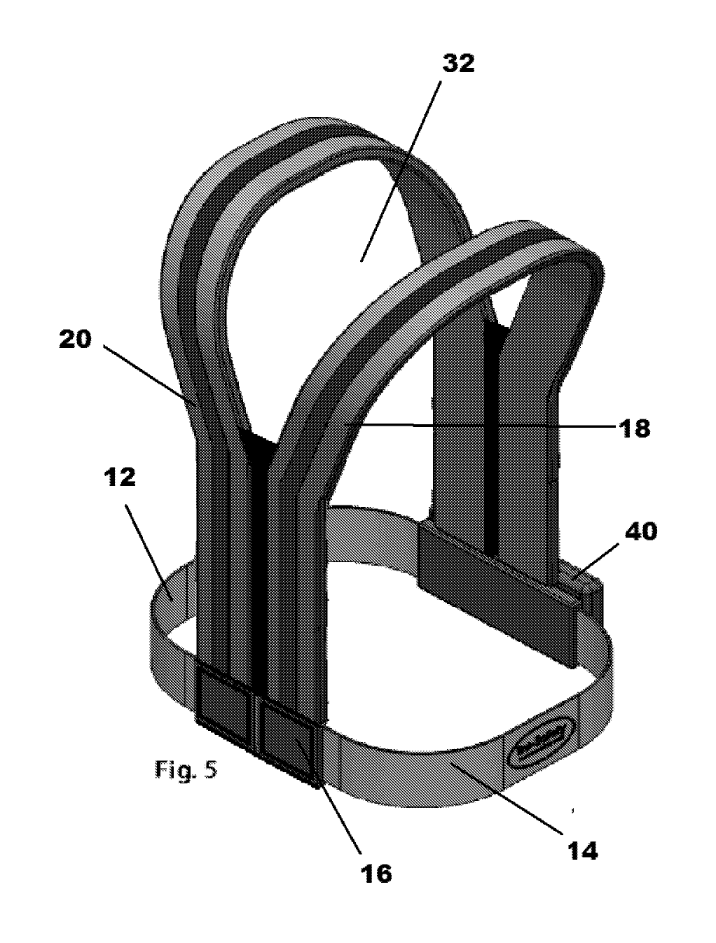

With reference now to the drawings, and in particular to FIGS. 1 through 5 thereof, a new wearable visibility increasing device embodying the principles and concepts of an embodiment of the disclosure and generally designated by the reference numeral 10 will be described.

As best illustrated in FIGS. 1 through 5, the visibility increasing harness assembly 10 generally comprises a belt 12,14 configured for extending around a person's torso. As can be seen in the Figures, the assembly 10 may include a pair of belts 12, 14. The belts 12, 14 may be conventional and include conventional coupling means including buckles or clips 16.

A right strap 18 is provided that has a first end 19 and a second end 23. The first 19 and second 23 ends are attached to the belt 14 using connector 16 so that the strap 18 traverses loop formed by the belt 14. A left strap 20 is provided that has a first end 21 and a second end 25. The first 21 and second 25 ends are attached to the belt section 12 using connector 16 so that the strap 20 traverses a loop formed by the belt 12. The strap 18 and 20 are configured to be extended over a person's shoulders. The strap 18, 20 have an outer surface 24 facing outwardly from the wearer of the strap 18, 20. The strap 18 includes a first portion 26 including the first ends 19, 21, a second portion 28 including the second end 21, 23, and a middle portion 30 positioned between the first 26 and second 28 portions. The middle portion 30 has an aperture 32 therein dividing the middle portion 30 into a pair of sections 34. The aperture 32 is configured to receive the person's head such that the sections 34 are on either side of the person's head and the middle portion 30 abutted against the person's shoulders.
A plurality of light emitters 36 is positioned on the outer surface 24. The LED light emitters 36 cover the outer surface 24 as indicated. The term “substantially cover” herein is meant to indicate that there is an absence of large gaps between the light emitters 36 such that the strap 18 appears to form an illuminated “Y” from both the front and back sides due to the even distribution of the LED light emitters 36. The light emitters 36 comprise light emitting diodes and may be provided in a plurality of colors. The light emitters 36 comprise of RGB programmable LEDs. Moreover, the light emitters 36 will display the colors and lighting sequences appropriate of the application it is selected for.
A power supply, such as a battery 40 including a current regulator, may be mounted on the belt 12, 14 to power the light emitters 36. The actuator 48 may further comprise a power actuator to turn the micro controller on or off.
The assembly 10 may include WAND 42 connected to the harness wirelessly wherein the WAND 42 also have light emitters 46 positioned thereon. The light emitters 46 on the WAND 42 are electrically coupled to the power supply 45 and the actuator 50. The light emitters 46 on the WAND 42, in particular, will assist a person in directing traffic. A control may be mounted within one or both of the WANDs 42 and may take the form of positioning detecting device 52 configured to detect the position of the WANDs 42 and relative to the straps 18, 20. For instance, an accelerometer may be used for such a purpose. Thus, when one of the WANDs 42 and is raised to a “stop” position, the light emitters 36, 46 thereon will emit only red light. When both WANDs 42 actuators 50 are released, the light emitters 36 on the straps may emit a standby blue color. If the WAND 42 is extended in a horizontal orientation and the actuator 50 is depressed, that the light emitters 36, 46 will emit a green color indicating to a driver that they may turn in the direction of the extended arm.
When both WANDs 42 are extended in a horizontal orientation and the actuators 50 are depressed, both the light emitters 36, 46 will emit a green color indicating to a driver that they may turn in the direction of the extended arms while the light emitters 36 in the back side will flash RED sequence at the same time to indicate that only those vehicles turning in the indicated position may proceed.
It should be understood that the above are only examples and that a control circuit or CPU 55 electrically coupled to the light emitters 36, 46 may be programmed in any fashion depending on the needs of the user of the assembly 10.

In use, the assembly 10 is worn by a person who requires added visibility. For example, the assembly 10 may be worn by a person directing vehicles, such as a traffic officer, or someone directing airplanes on runways. The light emitters 36, 46 will ensure that drivers clearly see the traffic officer and to provide high visibility to the hands of the officer as the officer directs the driver's actions. However, the assembly 10 may also be worn by Emergency services, Fire Fighters, Wreckers Services, Road construction Crews without WANDs and programmed with the appropriate colors and Light sequences. Runners, Bicyclist, Walkers would wear a much lighter version to increase visibility for safety purposes.

In use, the assembly 10 contains an actuator 38 to turn ON/OFF the front LED 36 when a police officer is approaching a scene, a flash light 26, and a camera 8.
Another embodiment may also be provided having a size well suited for a pet, such as a dog, to wear to make the pet highly visible during walks.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A harness assembly for increasing visibility of a person wearing said harness assembly, said harness assembly including:
a belt configured for extending around a person's torso;
a strap having a first end and a second end, said first and second ends each being attached to said belt, said strap being configured to extended over a person's shoulders, said strap having an outer surface;
a plurality of light emitters being positioned on said outer surface;
said strap including a first portion including said first end, a second portion including a second portion including said second end, and a middle portion positioned between said first and second portions, said middle portion having an aperture therein dividing said middle portion into a pair of sections, wherein said aperture is configured to receive the person's head.
